(19) United States
(12) Patent Application Publication
(10) Pub. No.: US 2026/0230717 A1
(43) Pub. Date: Aug. 6, 2026

(54) IMAGE SENSOR WITH REDUCED SENSITIVITY CONTROL

(71) Applicant: QUALCOMM Incorporated, San Diego, CA (US)

(72) Inventors: Micha Galor Gluskin, San Diego, CA (US); Jiafu Luo, Irvine, CA (US)

(21) Appl. No.: 19/047,296

(22) Filed: Feb. 6, 2025

(51) Int. Cl. H04N 23/81; H04N 23/62; H04N 23/667; H04N 23/73; H04N 23/745

(52) U.S. Cl. CPC H04N 23/81; H04N 23/62; H04N 23/667; H04N 23/73; H04N 23/745

(57) ABSTRACT

A system for capturing images includes an image sensor and processing circuitry. The processing circuitry receives an indication to capture an image using a reduced sensitivity mode and toggles a first voltage at a reset transistor for each pixel of the image sensor during an integration time. The processing circuitry alternates the first voltage between a first low voltage level and a first high voltage level at a first frequency, where the first high voltage level is less than a reset voltage used to reset photodiodes of the image sensor. In configurations with a four transistor (4T) pixel, the processing circuitry also toggles a second voltage at a transfer gate for each pixel during the integration time. The system determines the use of the reduced sensitivity mode based on integration time, flicker period, or user input. The apparatus can be implemented in various devices, including wireless communication devices.

### TECHNICAL FIELD

The disclosure relates to image processing including.

### BACKGROUND

Image capture systems often face challenges in managing sensitivity, particularly in scenarios requiring extended exposure under strong light conditions. Traditional methods to address this issue include reducing the aperture, using neutral density (ND) filters, or stacking multiple quick readouts. These methods, however, are either not feasible for mobile devices or introduce complexity and artifacts. In some use cases, extended exposure may be desirable for artistic effects. In other use cases, extended exposure may be desirable to avoid visual distortions in images. Visual distortions occur when the integration time is not an integer multiple of the flicker period, leading to unwanted artifacts. Existing solutions, such as digital compensation for flicker banding or proprietary technologies, attempt to mitigate these issues but often involve added costs, complexity, or power consumption.

### SUMMARY

This disclosure describes techniques for capturing an image, including techniques for capturing an image with reduced sensitivity. In one example, this disclosure describes an apparatus that includes an image sensor and processing circuitry coupled to the image sensor. The processing circuitry is configured to receive an indication to capture an image using a reduced sensitivity mode and to toggle a first voltage at a reset transistor for one or more pixels of the image sensor during an integration time. This toggling alternates the first voltage between a first low voltage level and a first high voltage level at a first frequency, where the first high voltage level is less than a reset voltage used to reset photodiodes of the image sensor.

For image sensors that use a four transistor (4T) pixel configuration, the processing circuitry may be further configured to toggle a second voltage at a transfer gate for one or more pixels of the image sensor during the integration time. This toggling alternates the second voltage between a second low voltage level and a second high voltage level at a second frequency, where the second high voltage level is less than a transfer voltage used to fully transfer respective charges from the photodiodes of the image sensor.

The techniques of the disclosure may also include determining the use of the reduced sensitivity mode based on the integration time and a flicker period. For example, the processing circuitry may determine a gain and the integration time for the image sensor, increase the integration time to match the flicker period, reduce the gain to be below one by triggering the reduced sensitivity mode. Additionally, the reduced sensitivity mode can be determined based on user input.

The benefits of using the techniques of the disclosure include the ability to manage exposure and sensitivity without introducing additional power consumption or artifacts, and without requiring additional components, such as Natural Density filters or mechanical apertures. The techniques of this disclosure provide flexibility in both 3T and 4T pixel configurations, allowing for high-quality, and flicker free, image capture under strong light conditions. By avoiding the need for added cost or pixel-level complexity, the techniques of this disclosure may simplify the mechanical requirements compared to variable aperture or ND filters. This results in clearer, more stable images and videos, even in challenging lighting environments.

In one example, this disclosure describes an apparatus configured to capture an image, the apparatus comprising an image sensor, and processing circuitry coupled to the image sensor, the processing circuitry configured to receive an indication to capture an image using a reduced sensitivity mode, toggle a first voltage at a reset transistor for one or more pixels of the image sensor during an integration time while capturing the image with the reduced sensitivity mode, and receive image data for the image captured with the reduced sensitivity mode.

In another example, this disclosure describes a method of capturing an image, the method comprising receiving an indication to capture an image using a reduced sensitivity mode, toggling a first voltage at a reset transistor for one or more pixels of an image sensor during an integration time while capturing the image with the reduced sensitivity mode, and receiving image data for the image captured with the reduced sensitivity mode.

In another example, this disclosure describes a non-transitory computer-readable storage medium storing instructions that, when executed, cause one or more processors of a device configured to capture an image to receive an indication to capture an image using a reduced sensitivity mode, and a first voltage at a reset transistor for one or more pixels of an image sensor during an integration time while capturing the image with the reduced sensitivity mode, and receive image data for the image captured with the reduced sensitivity mode.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform one or more of the example techniques described in this disclosure.

FIG. 2 is a block diagram of an example sensor module according to the techniques of this disclosure.

FIG. 3 is a block diagram illustrating an example three transistor (3T) pixel architecture according to the techniques of this disclosure.

FIG. 4 is a block diagram illustrating an example four transistor (4T) pixel architecture according to the techniques of this disclosure.

FIG. 5 illustrates a timing diagram for default operation in an image sensor according to the techniques of this disclosure.

FIG. 6 illustrates a timing diagram of a reduced sensitivity mode in an image sensor according to the techniques of this disclosure.

FIG. 7 is a flow chart illustrating an example process for adjusting integration time and gain according to the techniques of this disclosure.

FIG. 8 illustrates a flow chart illustrating an example process for capturing an image using a reduced sensitivity mode according to the techniques of this disclosure.

### DETAILED DESCRIPTION

Image capture systems often face challenges in managing sensitivity, particularly in scenarios that utilize extended exposure under strong light conditions. Extended exposure may be desirable for artistic effects and to avoid visual distortions in images, such as flicker or flicker banding. Visual distortions may occur when the integration time is not an integer multiple of the flicker period, leading to unwanted artifacts. Traditional methods to address this issue include reducing the aperture size, using neutral density (ND) filters, or stacking multiple quick readouts. These methods, however, are either not feasible for mobile devices or introduce complexity and artifacts.

Existing solutions, such as digital compensation for flicker banding or proprietary technologies, attempt to mitigate these issues but often involve added costs, complexity, or power consumption. Reducing the aperture is available on few mobile devices, and using ND filters is typically only feasible in stand-alone cameras. Stacking multiple quick readouts is generally only feasible in snapshot mode. Digital compensation for flicker banding artifacts may introduce additional power consumption and artifacts.

This disclosure describes an apparatus and method for reducing artifacts during extended exposure. The techniques of this disclosure include changes to the operation of an image sensor pixel that allows the image sensor pixel to gradually drain the photodiode during exposure, effectively lowering the pixel sensitivity. In one example, an image sensor may be configured to toggle a voltage at a reset transistor for one or more pixels of the image sensor during an integration time while capturing the image with a reduced sensitivity mode. This approach avoids the need for added cost or pixel-level complexity and simplifies the mechanical requirements compared to variable aperture or ND filters. The reduced sensitivity control can be implemented in both three transistor (3T) and four transistor (4T) pixel configurations, providing flexibility in managing exposure and sensitivity without introducing additional power consumption or artifacts.

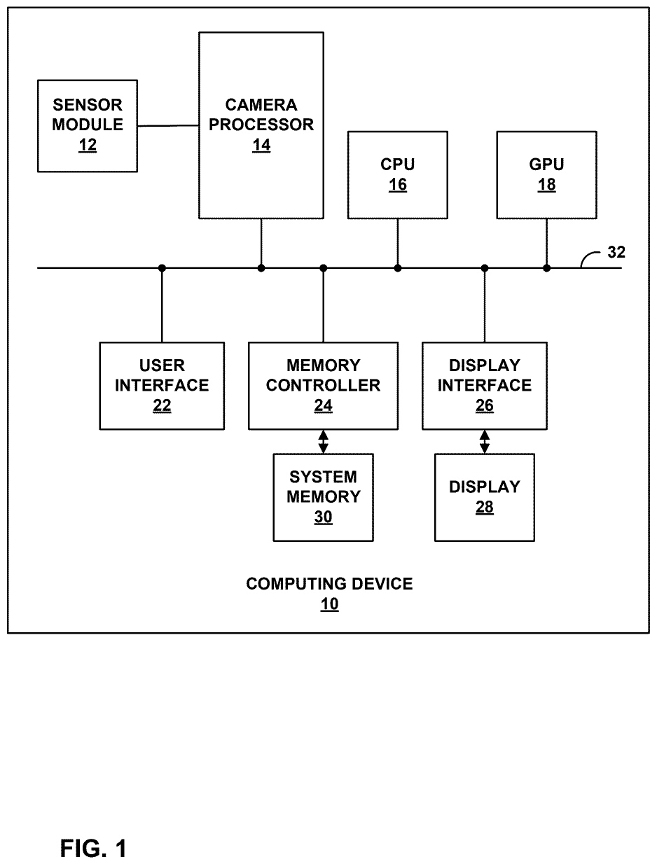

FIG. 1 is a block diagram of a device configured to perform one or more of the example techniques described in this disclosure for reduced sensitivity control in an image sensor. Examples of computing device 10 include a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), a landline telephone for teleconferencing, an Internet telephone, a handheld device such as a portable video game device or a personal digital assistant (PDA). Additional examples of computing device 10 include a personal music player, a video player, a display device, a camera, a television, a set-top box, a broadcast receiver device, a server, an intermediate network device, a mainframe computer or any other type of device that processes and/or displays graphical data.

As illustrated in the example of FIG. 1, computing device 10 includes sensor module 12, a camera processor 14, a central processing unit (CPU) 16, a graphical processing unit (GPU) 18, user interface 22, memory controller 24 that provides access to system memory 30, and display interface 26 that outputs signals that cause graphical data to be displayed on display 28. Although FIG. 1 illustrates sensor module 12 as part of the same device that includes camera processor 14, CPU 16, and GPU 18, the techniques described in this disclosure are not so limited. In some examples, camera processor 14, CPU 16, and GPU 18 and many of the various other components illustrated in FIG. 1 may be on a different device (e.g., a processing device) than sensor module 12.

Also, although the various components are illustrated as separate components, in some examples the components may be combined to form a system on chip (SoC). As an example, camera processor 14, CPU 16, GPU 18, and display interface 26 may be formed on a common integrated circuit (IC) chip. In some examples, one or more of camera processor 14, CPU 16, GPU 18, and display interface 26 may be in separate IC chips. Various other permutations and combinations are possible, and the techniques should not be considered limited to the example illustrated in FIG. 1. The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry.

The various units illustrated in FIG. 1 communicate with each other using bus 32. Bus 32 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different components shown in FIG. 1 is merely exemplary, and other configurations of computing devices and/or other image processing systems with the same or different components may be used to implement the techniques of this disclosure.

Camera processor 14 may be external to computing device 10; however, it may be possible for camera processor 14 to be internal to computing device 10, as illustrated. For instance, in some examples, sensor module 12 and camera processor 14 may form a pluggable camera for a desktop or laptop computer, and CPU 16, GPU 18, and the various other components may be part of the desktop or laptop computer. For ease of description, the examples are described with respect to the configuration illustrated in FIG. 1.

Sensor module 12 includes an image sensor with a plurality of sensor elements (e.g., photodiodes) arranged in a two-dimensional array. The sensor elements (e.g., “pixels”) may be CMOS (Complementary Metal-Oxide-Semiconductor) elements. Each pixel generates an electrical signal based on a luminance of the light incident to the sensor element. With filtering, such as Bayer filtering, the electrical signals generated by each of the sensor element indicate the luminance of a particular color.

In some examples, the pixels of the image sensor in sensor module 12 may be in a three transistor (3T) or a four transistor (4T) configuration. A 3T pixel configuration includes three primary transistors per pixel: a reset transistor (RST), a source follower transistor (SF), and a row select transistor (SEL). These components work together to capture and read out image signals with minimal complexity and power consumption. A 4T pixel configuration enhances the performance and functionality of image sensors by incorporating an additional transistor compared to the 3T configuration. The 4T pixel configuration includes four primary transistors per pixel: a reset transistor (RST), a source follower transistor (SF), a row select transistor (SEL), and a transfer gate transistor (TX). These components work together to capture and read out image signals with improved noise performance, higher dynamic range, and better image quality. The 4T pixel configuration may offer advantages over the 3T configuration, including improved noise performance, higher dynamic range, and reduced fixed pattern noise, resulting in clearer, more detailed, and more accurate images. Additionally, the 4T configuration may enable more efficient charge transfer and correlated double sampling (CDS), further enhancing image quality and sensor performance.

Camera processor 14 is configured to receive electrical signals as sensor signals from respective sensor elements of sensor module 12 and process the electrical signals to generate pixel data of an image frame. In some examples, camera processor 14 may be configured as a single-input-multiple-data (SIMD) architecture. Camera processor 14 may perform the same operations on electrical signals received from each of the sensor elements of sensor module 12. Each lane of the SIMD architecture may include an image pipeline. The image pipeline includes hardwire circuitry and/or programmable circuitry (e.g., at least one of fixed-function or programmable circuitry) to process the output of the sensors to generate pixel values for pixels. As will be explained in more detail below, camera processor 14 may be configured to cause sensor module 12 to operate in a reduced sensitivity mode in accordance with the techniques of this disclosure.

CPU 16 may comprise a general-purpose or a special-purpose processor that controls operation of computing device 10. A user may provide input to computing device 10 to cause CPU 16 to execute one or more software applications. The user may provide input to computing device 10 via one or more input devices (not shown) such as a keyboard, a mouse, a microphone, a touch pad or another input device that is coupled to computing device 10 via user interface 22. In some examples, a user may provide an input that causes sensor module 12 to capture images in the reduced sensitivity mode of this disclosure.

One example of the software application is a camera application. CPU 16 executes the camera application, and in response, the camera application causes CPU 16 to generate content that display 28 outputs. For instance, display 28 may output information such as light intensity, whether flash is enabled, and other such information. The user of computing device 10 may interface with display 28 to configure the manner in which the images are generated (e.g., with or without flash, focus settings, exposure settings, and other parameters). The camera application also causes CPU 16 to instruct camera processor 14 to process the images captured by sensor module 12 in the user-defined manner.

As one example, the user interacting with the camera application may be considered as a start of a camera session, and the end of the camera session may be after the user takes the picture or exits the camera application. In examples where device 10 is a digital camera, the start of the camera session may be when the user turns on the digital camera to take a picture or video.

GPU 18 may generate graphical information that provides the user information about the image frames to be captured. For instance, GPU 18 may generate a graphic that indicates whether flash is enabled, generate boxes around identified faces, etc.

Memory controller 24 facilitates the transfer of data going into and out of system memory 30. For example, memory controller 24 may receive memory read and write commands, and service such commands with respect to memory 30 in order to provide memory services for the components in computing device 10. Memory controller 24 is communicatively coupled to system memory 30. Although memory controller 24 is illustrated in the example of computing device 10 of FIG. 1 as being a processing circuit that is separate from both CPU 16 and system memory 30, in other examples, some or all of the functionality of memory controller 24 may be implemented on one or both of CPU 16 and system memory 30.

System memory 30 may store program modules and/or instructions and/or data that are accessible by camera processor 14, CPU 16, and GPU 18. For example, system memory 30 may store user applications (e.g., instructions for the camera application), resulting images from camera processor 14, etc. System memory 30 may additionally store information for use by and/or generated by other components of computing device 10. For example, system memory 30 may act as a device memory for camera processor 14. System memory 30 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 30 may include instructions that cause camera processor 14, CPU 16, GPU 18, and display interface 26 to perform the functions ascribed to these components in this disclosure. Accordingly, system memory 30 may be a computer-readable storage medium having instructions stored thereon that, when executed, cause one or more processors (e.g., camera processor 14, CPU 16, GPU 18, and display interface 26) to perform various functions.

In some examples, system memory 30 is a non-transitory storage medium. The term “non-transitory” indicates that the storage medium is not embodied in a carrier wave or a propagated signal. However, the term “non-transitory” should not be interpreted to mean that system memory 30 is non-movable or that its contents are static. As one example, system memory 30 may be removed from computing device 10, and moved to another device. As another example, memory, substantially similar to system memory 30, may be inserted into computing device 10. In certain examples, a non-transitory storage medium may store data that can, over time, change (e.g., in RAM).

Camera processor 14, CPU 16, and GPU 18 may store image data, and the like in respective buffers that are allocated within system memory 30. Display interface 26 may retrieve the data from system memory 30 and configure display 28 to display the image represented by the generated image data. In some examples, display interface 26 may include a digital-to-analog converter (DAC) that is configured to convert the digital values retrieved from system memory 30 into an analog signal consumable by display 28. In other examples, display interface 26 may pass the digital values directly to display 28 for processing.

Display 28 may include a monitor, a television, a projection device, a liquid crystal display (LCD), a plasma display panel, a light emitting diode (LED) array, or another type of display unit. Display 28 may be integrated within computing device 10. For instance, display 28 may be a screen of a mobile telephone handset or a tablet computer. Alternatively, display 28 may be a stand-alone device coupled to computing device 10 via a wired or wireless communications link. For instance, display 28 may be a computer monitor or flat panel display connected to a personal computer via a cable or wireless link.

In one or more examples of the disclosure, sensor module 12 may be configured to operate in a reduced sensitivity mode. In general, the reduced sensitivity mode may allow for long exposure times without saturating the image sensor. Long exposure times may be desired for artistic effects or to avoid light source flicker artifacts, including global flicker and flicker banding.

Flicker, in the context of a digital image sensor, refers to the unwanted visual artifacts that appear in captured images or videos when the light source fluctuates in intensity. This phenomenon is particularly common with artificial lighting, such as fluorescent lights, LED lights, and other sources powered by alternating current (AC). These light sources typically flicker at a frequency that is twice the electricity frequency (e.g., 100 Hz or 120 Hz, depending on the region). Although this flicker is often imperceptible to the human eye, it can be captured by digital image sensors, leading to visible artifacts.

Flicker arises when the integration time of the image sensor is not synchronized with the flicker frequency of the light source. In the context of an image sensor, integration time refers to the duration for which the sensor's photodiodes are exposed to light to collect charge. This period is analogous to the exposure time or shutter speed in traditional photography. During the integration time, the photodiodes accumulate electrical charge proportional to the intensity of the incident light. After the integration time elapses, the accumulated charge is read out and processed to form an image. The integration time affects the brightness and quality of the captured image, as well as the ability to avoid artifacts such as flicker when the integration time is not an integer multiple of the flicker period.

If the integration time is not an integer multiple of the flicker period, the sensor captures varying light intensities within a single frame, resulting in banding or striping artifacts. These artifacts manifest as alternating bright and dark bands across the image. The severity of the flicker artifacts depends on the mismatch between the integration time and the flicker period, as well as the characteristics of the light source.

Global flicker and flicker banding are two types of visual artifacts that can occur in images or videos captured under certain lighting conditions, particularly with artificial light sources. Global flicker refers to the overall fluctuation in brightness across a sequence of frames. This phenomenon occurs when the light source itself fluctuates in intensity, typically due to the AC power supply. The sequence of frames appears to brighten and dim in-sync with the flicker frequency of the light source, which is often imperceptible to the human eye but can be captured by digital image sensors. Flicker banding, on the other hand, manifests as alternating dark and light horizontal or vertical bands across the image or video. This specific type of artifact arises when the integration time of the image sensor is not synchronized with the flicker period of the light source. As a result, e.g., when using a rolling shutter, different parts of the image are exposed to varying light intensities within a single frame, leading to the appearance of bands.

In digital image capture, global shutter and rolling shutter are two different methods used to expose the image sensor to light and capture an image. The image sensor of sensor module 12 may be configured with either a global shutter or a rolling shutter. A global shutter captures an image by exposing all the pixels on the image sensor simultaneously. This means that the entire sensor is exposed to light for the same duration, and the charge accumulated in each pixel is read out at the same time. This method is analogous to the traditional mechanical shutter in film cameras, where the entire frame is exposed at once.

The use of a global shutter can help mitigate flicker issues because the global shutter captures the entire frame at the same moment in time. If the exposure time is synchronized with the flicker period of the light source, global flicker can be minimized. However, if the exposure time is not an integer multiple of the flicker period, global flicker may still occur, causing consecutive frames to fluctuate in brightness.

A rolling shutter captures an image by exposing the pixels on the image sensor sequentially, typically line by line from top to bottom. This means that different parts of the image are exposed at slightly different times. The readout process occurs in a rolling fashion, which can lead to distortions if there is motion in the scene or if the light source flickers. Rolling shutter is more susceptible to flicker issues, particularly flicker banding. Since different lines of the image sensor are exposed at different times, any fluctuations in the light source's intensity can cause alternating dark and light bands to appear across the image. This effect is especially pronounced in video recordings or high-speed photography, where the rapid capture of frames exacerbates the flicker banding artifacts. Synchronizing the integration time with the flicker period can help reduce flicker banding, but it is more challenging to achieve with a rolling shutter compared to a global shutter.

Some example techniques for addressing flicker include reducing the aperture size, using neutral density (ND) filters, or stacking multiple quick readouts. Other existing solutions, such as digital compensation for flicker banding or proprietary technologies, attempt to mitigate these issues but often involve added costs, complexity, or power consumption. Reducing the aperture is available on few mobile devices and using ND filters is typically only available for use in stand-alone cameras. Stacking multiple quick readouts is generally only usable in snapshot mode. Digital compensation for flicker banding artifacts may introduce additional power consumption and artifacts.

This disclosure describes an apparatus and method for reducing artifacts during extended exposure. The techniques of this disclosure include a reduced sensitivity mode that includes changes to the operation of an image sensor pixel that allows the image sensor pixel to gradually drain the photodiode during exposure, effectively lowering the pixel sensitivity. In one example, an image sensor may be configured to toggle a voltage at a reset transistor for one or more pixels of the image sensor during an integration time while capturing the image with a reduced sensitivity mode. Toggling the voltage at the reset transistor may allow for gradual draining of the photodiode. This approach avoids the need for added cost or pixel-level complexity and simplifies the mechanical requirements compared to variable aperture or ND filters. The reduced sensitivity control can be implemented in both 3T and four transistor 4T pixel configurations, providing flexibility in managing exposure and sensitivity without introducing additional power consumption or artifacts.

The techniques of this disclosure may allow for reduced flicker artifacts with little added cost or pixel level complexity to the image sensor. The techniques of this disclosure are also simpler and lower in cost than the use of variable apertures or ND filters. Also, the techniques of this disclosure do not require additional power or introduce additional artifacts compared to digital banding compensation or fast readout and stacking.

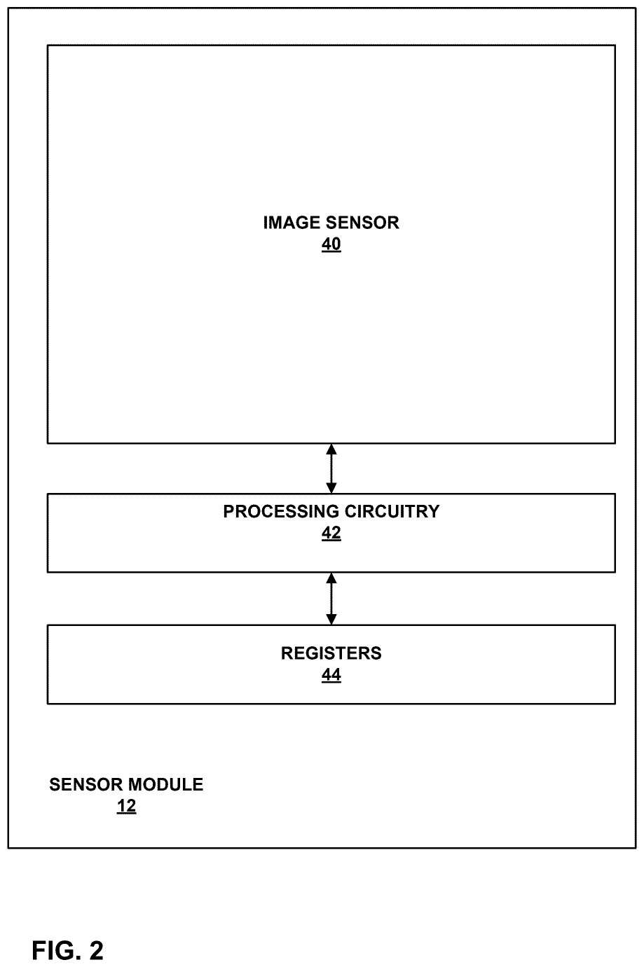

FIG. 2 is a block diagram of an example sensor module according to the techniques of this disclosure. Sensor module 12, as illustrated in FIG. 2, comprises several components that work together to achieve the reduced sensitivity control in an image sensor. These components include image sensor 40, processing circuitry 42, and registers 44. Image sensor 40 contains an array of photodiodes that convert incident light into electrical signals. Each photodiode in the image sensor 40 accumulates charge proportional to the intensity and duration of the incident light during the integration time. Image sensor 40 can be configured in either a three transistor (3T) or four transistor (4T) pixel architecture, depending on the specific implementation.

In the context of reduced sensitivity control, processing circuitry 42 may configured to control the operation of image sensor 40 to toggle a reset voltage at a reset transistor for one or more pixels during the integration time. This toggling allows for controlled drainage of the accumulated charge on the photodiode, effectively lowering the pixel sensitivity and preventing saturation in high light conditions. In some examples, processing circuitry 42 may receive an indication to capture an image using the reduced sensitivity mode and controls the toggling of the reset voltage at the reset transistor for one or more pixels of the image sensor 40. The processing circuitry 42 alternates the reset voltage between a low voltage level and a high voltage level at a specified frequency, where the high voltage level is less than the typical reset voltage used to reset the photodiodes.

In configurations with a four transistor (4T) pixel architecture, processing circuitry 42 may also be configured to toggle a second voltage at the transfer gate for one or more pixels during the integration time. For example, processing circuitry 42 may cause image sensor 40 to alternate the second voltage between a second low voltage level and a second high voltage level at a second frequency, wherein the second high voltage level is less than a transfer voltage used to fully transfer respective charges from the photodiodes of the image sensor. In one example, at least one of the first high voltage level (e.g., for the RST) and the second high voltage level (e.g., for the TX) are the same, or the first frequency and the second frequency are the same. In other examples, at least one of the first high voltage level and the second high voltage level are different, or the first frequency and the second frequency are different.

In the examples of the disclosure described below, toggling the voltage at the RST gate or TX gate may include alternating the RST and/or TX voltage between a low voltage level and a high voltage level at a specified frequency, where the high voltage level is less than the typical reset voltage used to reset the photodiodes and/or floating diffusion nodes. However, toggling voltages at the RST gate or TX gate may involve other characteristics of the voltage signal. For example, different up/down duty cycle configurations of the RST gate or TX gate may be used. In general, an up/down duty cycle refers to the proportion of time a signal is in its “on” (or high) state versus its “off” (or low) state during one complete cycle. An up/down duty cycle may be expressed as a percentage, or may be expressed in clock cylces, and is a characteristic of periodic signals such as square waves or pulse signals. In other examples, toggling the voltage at the RST gate or TX gate may include the use of a pulse spread approach, rather than simple repetitive toggling. In other examples, toggling the voltage at the RST gate or TX gate may include changing the pulse density of the on and off states of the RST and TX voltage.

In general, processing circuitry 42 may be configured to toggle the RST voltage or the RST voltage and TX voltage for one or more pixels in the image sensor. In some examples, processing circuitry 42 may be configured to toggle the RST voltage or the RST voltage and TX voltage for every pixel in the image sensor. That is, the RST voltage or the RST voltage and TX voltage is toggled for each photodiode. In other examples, processing circuitry 42 may be configured to toggle the RST voltage or the RST voltage and TX voltage for a subset of the pixels in image sensor. For example, pixels for which the RST voltage or RST voltage and TX voltage are toggled may be placed into repeating pixels of one color in a quad color filter array (QCFA) pattern, such as Bayer filter. In other examples, pixels for which the RST voltage or RST voltage and TX voltage are toggled may be placed in patterns of interleaving lines, interleaving columns, interleaving pixels, or in checkerboard patterns, such as in monochrome sensors.

As described above, processing circuitry 42 may receive an indication to capture an image using the reduced sensitivity mode. Such an indication may be stored in registers 44. In some examples, registers 44 may include a specific register that indicates to processing circuitry 42 to use the reduced sensitivity mode. In other examples, processing circuitry 42 may be configured to determine the reduced sensitivity mode based on a gain register of registers 44 having a value less than 1. Other registers in register 44 may include a register that indicates the integration time, as well as other control parameters and settings used by the processing circuitry 42 to manage the reduced sensitivity mode and/or other modes of image sensor 40. For example, these registers 44 may include values for the toggling frequency, voltage levels, and other configuration settings used for the operation of the image sensor 40 in reduced sensitivity mode. The registers 44 allow for programmable control of the image sensor 40, enabling adjustments to be made based on specific requirements or user input. Processing circuitry 42 accesses the registers 44 to retrieve the parameters and apply them during the image capture process.

As on example, camera processor 14 of FIG. 1 may be configured to set the values of registers 44 based on an automatic exposure control (AEC) algorithm. Camera processor 14 may measure the ambient light conditions using a light meter or by analyzing the initial frames captured by image sensor 40. Camera processor 14 assesses the overall brightness and contrast of the scene to understand the lighting environment. Based on this initial light measurement, camera processor 14 calculates the optimal exposure settings, determining the appropriate integration time and sensor gain to ensure proper exposure.

To set the integration time, camera processor 14 may determine the measured light intensity. In bright conditions, camera processor 14 may use a shorter integration time to prevent overexposure, while in low-light conditions, camera processor 14 may determine a longer integration time to ensure sufficient light is captured. Camera processor 14 then adjusts the sensor gain (e.g., by writing to registers 44) to amplify the signal generated by the photodiodes. Camera processor 14 sets the gain based on the integration time and the desired brightness level, increasing the gain in low-light conditions to boost the signal and reducing it in bright conditions to avoid saturation and noise.

Camera processor 14 may also evaluate the flicker period of artificial light sources, such as fluorescent or LED lights powered by alternating current (AC). To avoid flicker artifacts, camera processor 14 may adjust the integration time to be an integer multiple of the flicker period. If the calculated integration time is not an integer multiple of the flicker period, camera processor 14 may modify the integration time to match the flicker period and compensates by adjusting the gain accordingly.

Camera processor 14 may continuously fine-tune the integration time and gain settings based on real-time feedback from image sensor 40. Camera processor 14 may analyze the captured frames to better ensure optimal exposure and make adjustments to maintain consistent image quality. In scenarios where the light intensity is extremely high, camera processor 14 may implement a reduced sensitivity mode. As discussed above, camera processor 14 may indicate the reduced sensitivity mode in registers 44 using an explicit mode register or by setting the gain register to a value less than 1. The reduced sensitivity mode includes toggling the reset and transfer gate voltages during the integration time to partially drain the accumulated charge in the photodiodes, effectively reducing pixel sensitivity and preventing saturation and clipping while maintaining the desired brightness level. In addition, the reduced sensitivity mode may reduce or eliminate flicker artifacts, including global flicker and/or flicker banding, regardless of whether image sensor 40 uses a global shutter or a rolling shutter.

In some examples, processing circuitry 42 and/or camera processor 14 may also be configured to compensate for non-linear charge drainage digitally. For example, non-linear drainage characteristics may be stored in a lookup table that indicates how each digital value readout from a photodiode of image sensor 40 may be compensated.

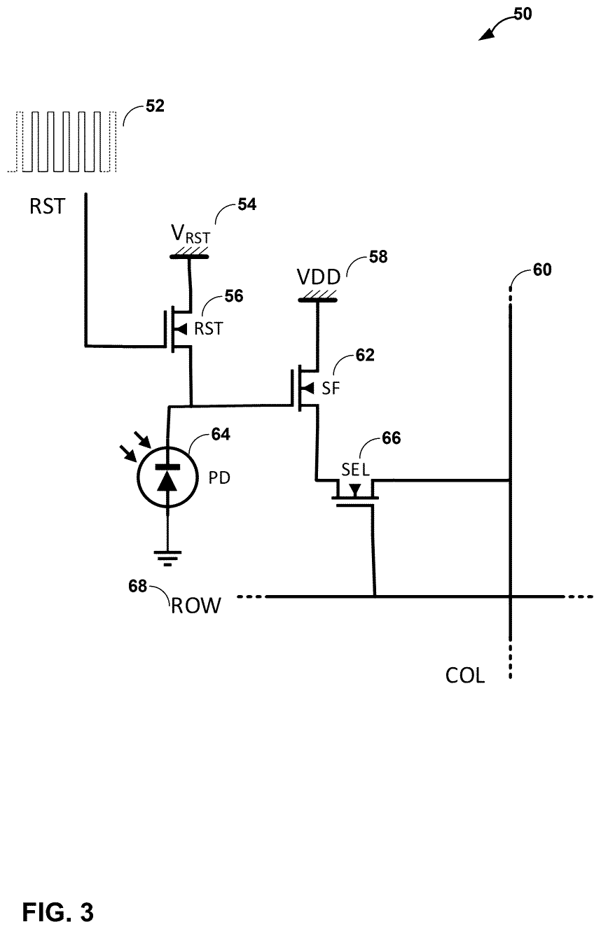

FIG. 3 is a block diagram illustrating an example three transistor (3T) pixel architecture 50 according to the techniques of this disclosure. Photodiode (PD) 64 is a photodiode that converts incident light into an electrical charge. The amount of charge accumulated in PD 64 is proportional to the intensity and duration of the incident light. The more light accumulated at PD 64, the lower the output voltage at the end of the integration time. VDD 58 is the supply voltage for the image sensor circuitry. VDD 58 provides the power for the operation of the reset transistor (RST) 56, source follower (SF) transistor 62, PD 64, and other components in 3T pixel architecture 50.

COL 60 represents the column line in the image sensor array. COL 60 is used to read out the signal from photodiode (PD) 64 after the integration period. The signal on COL 60 is influenced by the amount of charge accumulated in PD 64, which may be affected by the toggling of the reset transistor 56 during the reduced sensitivity mode, as will be described below. COL 60 is connected to SF 62 (e.g., through SEL 66 in FIG. 3), which buffers the signal before processing circuitry 42 (see FIG. 2) reads out the signal.

SF 62 is the source follower transistor that buffers the signal from photodiode 64 before the signal is read out on COL 60. SF 62 provides a high input impedance and low output impedance, ensuring that the signal from photodiode 64 is accurately transferred to COL 60.

Row select transistor (SEL) 66 enables the readout of the signal from PD 64. SEL 66 is activated by the row select signal, allowing the buffered signal from SF 62 to be transferred to the COL 60. The operation of SEL 66 is synchronized with the readout process, ensuring that the correct pixel signals are read out at the appropriate times.

ROW 68 represents the row line in the image sensor array. ROW 68 is used to select the specific row of pixels to be read out. ROW 68 controls the activation of SEL 66, enabling the readout of the signal from PD 64 in the selected row. ROW 68 is part of the overall addressing scheme that allows for the sequential readout of pixel signals from the image sensor array.

RST 56 is the reset transistor that controls the application of the reset voltage to PD 64. RST 56 is activated by RST voltage 52, allowing V_RST 54 to reset PD 64. During the reduced sensitivity mode, RST 56 is toggled at a high frequency, typically in the kilohertz range, to intermittently apply the reset voltage. This high-frequency toggling causes PD 64 to drain some of the charge during the integration period, reducing the overall sensitivity of the pixel.

V_RST 54 represents the reset voltage level applied to RST 56. V_RST 54 is typically set to a high voltage level that fully resets PD 64. In some implementations, V_RST 54 may be the same as VDD 58 to avoid another signal line. V_RST 54 is responsible for resetting PD 64 to a known state before the start of a new integration period. This reset operation ensures that PD 64 starts with no residual charge, which could otherwise affect the accuracy of the captured image.

Processing circuitry 42 may cause image sensor 40 to toggle RST voltage 52 during the integration time to achieve reduced sensitivity. The toggling frequency and voltage levels may be adjusted such that PD 64 drains some of the photodiode charge during exposure, effectively lowering the pixel sensitivity. Adjustment to the toggling frequency and voltage levels may achieve different levels of sub 1.0 gain (e.g., 0.25 gain, 0.5 gain, 0.75 gain, etc.). In a conventional image sensor, pixel gain may be 1.0 or higher. The reduced sensitivity mode of this disclosure allows for gains lower than 1.0.

In the reduced sensitivity mode, the RST voltage 52 may be programmed to a lower voltage level than the typical reset voltage. This lower voltage level allows for partial resetting of PD 64, enabling the gradual drainage of charge of PD 64 during the integration period.

The process of toggling RST voltage 52 during the integration time may include several steps and considerations to better ensure that the photodiode's sensitivity is effectively lowered without introducing artifacts or compromising image quality. Initially, before the start of a new integration period, PD 64 is reset to a known state to ensure that no residual charge affects the accuracy of the captured image. This is accomplished by applying a high reset voltage (V_RST) to RST 56, which fully resets the PD 64.

During the integration time, RST voltage 52 is toggled between a low voltage level and a high voltage level at a high frequency, typically in the kilohertz range. This high-frequency toggling achieves the reduced sensitivity because PD 64 is gradually drained. When RST voltage 52 is at the low voltage level, RST 56 is turned off, allowing PD 64 to accumulate charge based on the incident light. Conversely, when RST voltage 52 is at the high voltage level, RST 56 is turned on, allowing some of the accumulated charge in PD 64 to drain away.

The high-frequency toggling of RST voltage 52 causes PD 64 to be periodically and partially reset during the integration time. This periodic and partial resetting allows for controlled drainage of the accumulated charge. The amount of charge drained depends on the duration and frequency of the high voltage level applied to RST 56. By controlling these parameters, the sensitivity of PD 64 can be effectively reduced.

In the reduced sensitivity mode, the high voltage level of RST voltage 52 is set to a lower value than the typical reset voltage (V_RST). This lower voltage level allows for partial resetting of PD 64, meaning that only a portion of the accumulated charge is drained during each toggling cycle. This partial resetting prevents PD 64 from becoming fully saturated in high light conditions, thereby reducing its sensitivity.

The high-frequency toggling of RST voltage 52 may be designed to be fast enough to avoid introducing artifacts such as flicker or banding in the captured image. Control of the toggling frequency and voltage levels causes PD 64 to drain charge smoothly and consistently, resulting in a stable and high-quality image.

The reduced sensitivity mode achieved through the toggling of RST voltage 52 offers several benefits. By draining some of the accumulated charge, PD 64 is less likely to become saturated, preventing clipping in high light conditions. The controlled drainage of charge better ensures that the captured image maintains high quality without artifacts. Additionally, this technique avoids the need for additional mechanical components such as variable apertures or ND filters, simplifying the overall design and reducing costs.

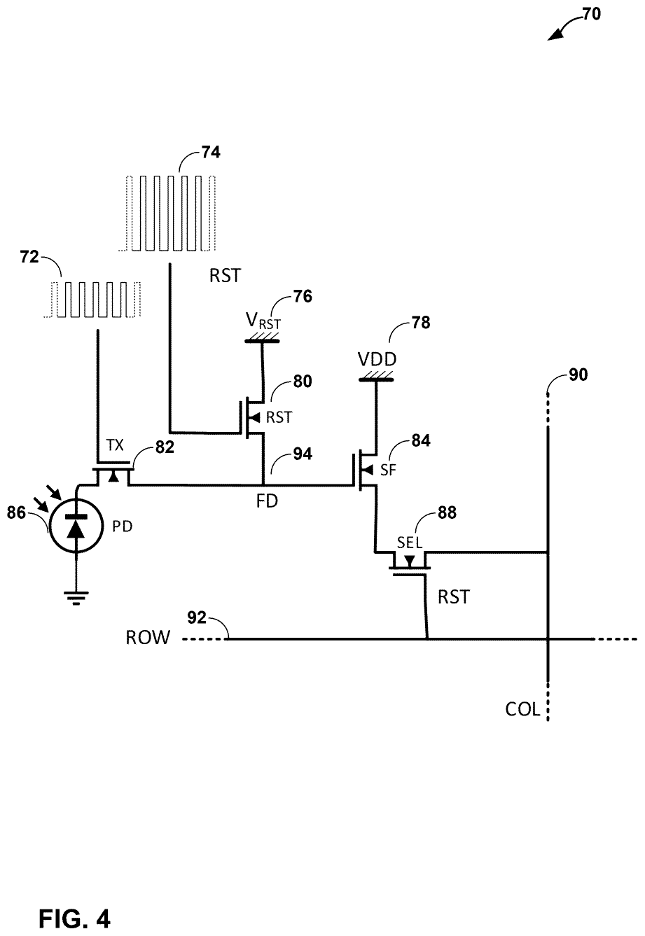

FIG. 4 is a block diagram illustrating an example four transistor (4T) pixel architecture 70 according to the techniques of this disclosure. Photodiode (PD) 86 is a photodiode that converts incident light into an electrical charge. The amount of charge accumulated in PD 86 is proportional to the intensity and duration of the incident light. The more light accumulated at PD 86, the lower the output voltage at the end of the integration time. VDD 78 is the supply voltage for the image sensor circuitry. VDD 78 provides the power for the operation of the reset transistor (RST) 80, source follower (SF) transistor 84, PD 86, and other components in 4T pixel architecture 70.

COL 90 represents the column line in the image sensor array. COL 90 is used to read out the signal from PD 86 after the integration period. The signal on COL 90 is influenced by the amount of charge accumulated in PD 86, which may be affected by the toggling of the reset transistor 80 and transfer gate (TX) 82 during the reduced sensitivity mode, as will be described below. COL 90 is connected to SF 84, which buffers the signal before processing circuitry 42 (see FIG. 2) reads out the signal.

SF 84 is the source follower transistor that buffers the signal from photodiode 86 before the signal is read out on COL 90. SF 84 provides a high input impedance and low output impedance, ensuring that the signal from photodiode 86 is accurately transferred to COL 90.

Row select transistor (SEL) 88 enables the readout of the signal from PD 86. SEL 88 is activated by the row select signal, allowing the buffered signal from SF 84 to be transferred to the COL 90. The operation of SEL 88 is synchronized with the readout process, ensuring that the correct pixel signals are read out at the appropriate times.

ROW 92 represents the row line in the image sensor array. ROW 92 is used to select the specific row of pixels to be read out. ROW 92 controls the activation of SEL 88, enabling the readout of the signal from PD 86 in the selected row. ROW 92 is part of the overall addressing scheme that allows for the sequential readout of pixel signals from the image sensor array.

RST 80 is the reset transistor that controls the application of the reset voltage to PD 86. RST 80 is activated by RST voltage 74, allowing V_RST 76 to reset PD 86. During the reduced sensitivity mode, RST 80 is toggled at a high frequency, typically in the kilohertz range, to intermittently apply the reset voltage, as described above. This high-frequency toggling causes PD 86 to drain some of the charge during the integration period, reducing the overall sensitivity of the pixel.

V_RST 76 represents the reset voltage level applied to RST 80. V_RST 76 is typically set to a high voltage level that fully resets PD 86. V_RST 76 is responsible for resetting PD 86 to a known state before the start of a new integration period. This reset operation ensures that PD 86 starts with no residual charge, which could otherwise affect the accuracy of the captured image.

Similar to that discussed above for the 3T architecture, processing circuitry 42 may cause image sensor 40 to toggle RST voltage 74 during the integration time to achieve reduced sensitivity. Toggling RST voltage 74 may reduce the charge in floating diffusion (FD) 94. Combined with toggling transfer voltage 72 at TX 82, charge may be drained from PD 86, thus lowering the pixel sensitivity. The toggling frequency and voltage levels may be adjusted such that charge is drained from FD 94. Adjustment to the toggling frequency and voltage levels may achieve different levels of sub 1.0 gain (e.g., 0.25 gain, 0.5 gain, 0.75 gain, etc.). In convention image sensor, pixel gain may be 1.0 or higher. The reduced sensitivity mode of this disclosure allows for gains lower than 1.0.

In addition, for 4T pixel architecture 70, processing circuitry 42 may be further configured to toggle transfer voltage 72 at TX 82. TX 82, or transfer gate, controls the transfer of charge from the photodiode 86 to the floating diffusion (FD) 94. During the integration period, TX 82 remains off, allowing the photodiode 86 to accumulate charge proportional to the incident light. When the integration period ends, TX 82 is activated, enabling the transfer of the accumulated charge to the FD 94 for readout. In the reduced sensitivity mode, processing circuitry 42 toggles the transfer voltage 72 at TX 82 during the integration time. This toggling alternates the voltage between a low level and a high level at a specified frequency, where the high level is less than the typical transfer voltage. This controlled toggling allows for partial transfer of the charge, effectively reducing the sensitivity of the pixel. Toggling transfer voltage 72 and TX gate 82 may increase black level and noise performance while operating in the reduced sensitivity mode.

FD 94, or floating diffusion, is a region where the charge accumulated in the photodiode 86 is transferred after the integration period. FD 94 temporarily stores the charge before the signal is read out by the processing circuitry. The transfer of charge to FD 94 is controlled by TX 82. In the reduced sensitivity mode, the toggling of transfer voltage 72 at TX 82 allows for partial transfer of the charge, effectively reducing the sensitivity of the pixel. FD 94 plays a role in the readout process, ensuring that the accumulated charge is accurately transferred and processed to generate the final image signal.

In some examples, transfer voltage 72 and RST voltage 74 may have the same high voltage levels, low voltage levels, frequencies, and phases. In other examples, one or more of the high voltage levels, low voltage levels, frequencies, or phases of transfer voltage 72 and RST voltage 74 may be different.

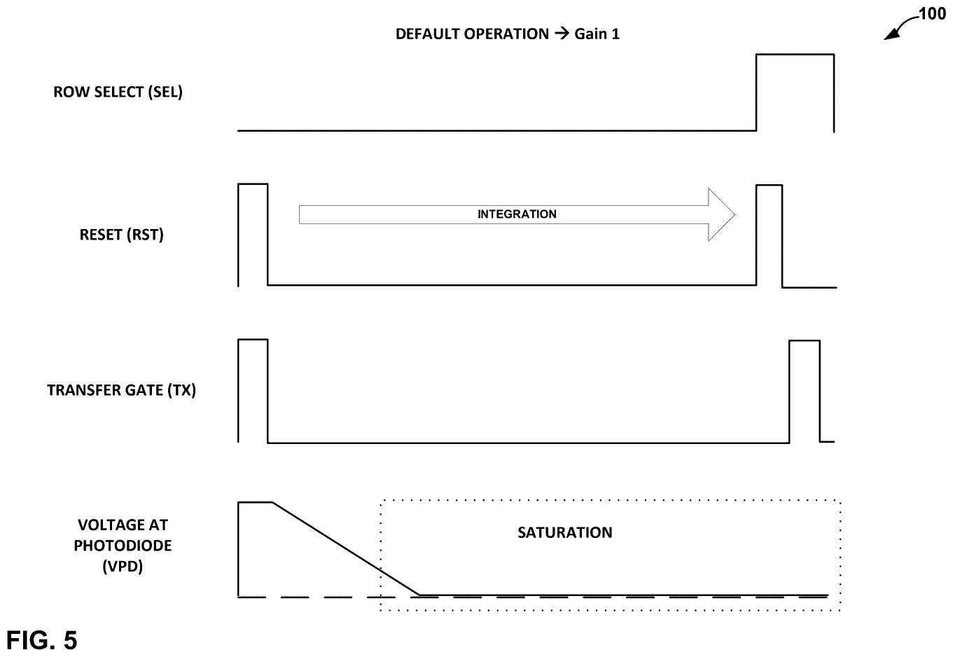

FIG. 5 illustrates a timing diagram 100 for default operation in an image sensor according to the techniques of this disclosure. Timing diagram 100 illustrates the behavior of various control signals and the voltage at the photodiode during the integration period. The Row Select (SEL) signal is initially low, indicating that the row of pixels is not selected for readout. The SEL signal then transitions to a high state, indicating the start of the readout period for the selected row.

As shown in FIG. 5, the Reset (RST) signal and the transfer gate (TX) signal both go high. The RST signal resets the floating diffusion node and allows the photodiode to drain with the TX signal high at the same time. When the TX signal goes low, the photodiode starts to start accumulate charge. The RST signal typically goes low after the TX signal goes low. When the row select (SEL) signal goes high, the RST signal goes high as well. As such, the floating diffusion node is reset. The RST signal goes low and the sensors takes some time to read out the first data point through a column line. Then, the TX signal goes high to transfer the photodiode signal to the floating diffusion node. The TX signal goes low and the sensors takes some time to readout a second data point through column line. Processing circuitry in the sensor may be perform correlated double sampling (CDS) by subtracting the first and second data points. The difference is proportional to actual signal from the photodiode. The SEL signal then goes low. In some implementations, the SEL signal can go low the second data point is readout.

The voltage at the photodiode (VPD) decreases during the integration period as the photodiode accumulates charge. The VPD reaches a saturation level when the photodiode is exposed to strong light for a relatively long integration time. The saturation level indicates that the photodiode has accumulated the maximum charge the photodiode can hold, and any additional light exposure will not decrease the voltage further. The timing diagram in FIG. 5 demonstrates the default operation of the image sensor with a gain of one (or greater), where the photodiode voltage becomes saturated due to a long integration time. This saturation can lead to clipping and loss of image detail in high light conditions.

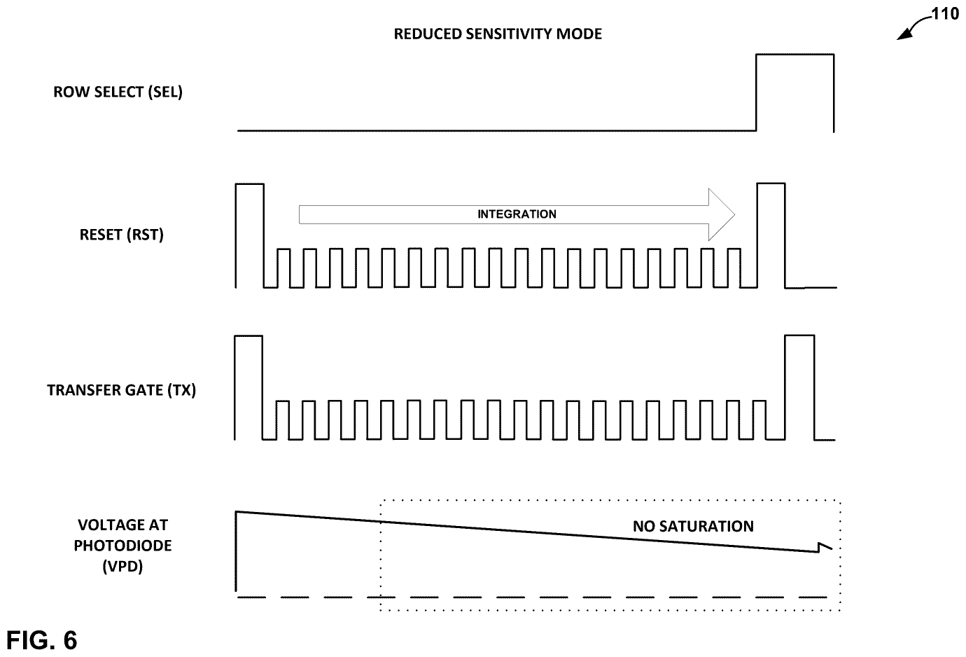

FIG. 6 illustrates a timing diagram 110 of a reduced sensitivity mode in an image sensor according to the techniques of this disclosure. Timing diagram 110 illustrates the behavior of various control signals and the voltage at the photodiode during the integration period during a reduced sensitivity mode of operation. The Row Select (SEL) signal is initially low, indicating that the row of pixels is not selected for readout. The SEL signal then transitions to a high state, indicating the start of the readout period for the selected row.

The RST signal and TX signal operate in the same manner as described above with reference to FIG. 5, except that the RST signal and TX signal are toggled during integration time. Toggling of the TX signal allows for partial drain of the photodiode. RST signal toggling prevents too much charge from being drained from the photodiode to the floating diffusion node.

The voltage at the photodiode (VPD) decreases during the integration period as the photodiode accumulates charge. However, due to the high-frequency toggling of the TX and RST signals, the VPD does not reach the saturation level, even with a relatively long integration time. This prevents clipping and loss of image detail in high light conditions. Timing diagram 110 in FIG. 6 demonstrates the operation of the image sensor in reduced sensitivity mode, where the photodiode voltage does not become saturated due to the controlled drainage of charge during the integration period. This results in high-quality image capture without artifacts, even in challenging lighting environments.

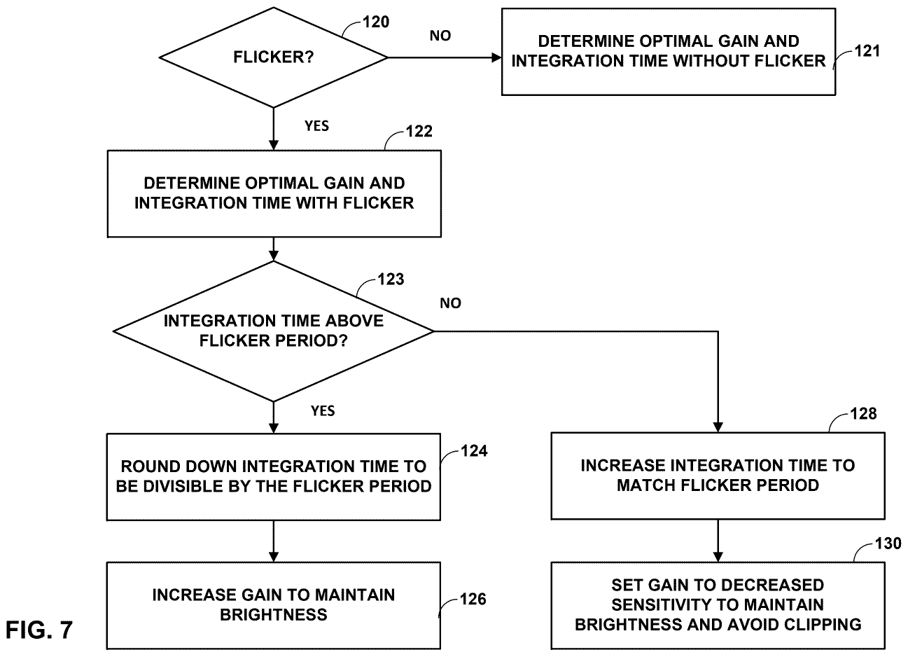

FIG. 7 is a flow chart illustrating an example process for adjusting integration time and gain according to the techniques of this disclosure. The techniques of FIG. 7 may be performed by camera processor 14 while executing an automatic exposure control algorithm. Camera processor 14 may first determine whether or not there is flicker (120). If there is no flicker, camera processor may determine an optimal gain an integration time without considerations for flicker (121). Determining the optimal gain and integration time may include calculating the appropriate values for gain and integration time based on the current lighting conditions and desired image quality. As there is no flicker in this situation, camera processor 14 may not need to limit exposure time.

If flicker is determined to present at 120, camera processor 14 may determine the optimal gain and integration time with flicker (122). Again, determining the optimal gain and integration time may include calculating the appropriate values for gain and integration time based on the current lighting conditions and desired image quality. In this case, the optimal gain and integration time may also be dependent on the flicker period. As one example, for power network flickering, the flicker period may be calculated as 1/(F*2), where F is the frequency of the power network. A frequency of 50 Hz equals a 10 ms flicker period. A frequency of 60 Hz equals an 8.33 ms flicker period.

Camera processor 14 then evaluates whether the integration time is above (e.g., longer than) the flicker period (123). If yes at 123, camera processor 14 rounds down the integration time to be divisible by the flicker period (124). This ensures that the integration time is an integer multiple of the flicker period, which helps to minimize flicker artifacts. Following the adjustment of the integration time, camera processor 14 increases the gain to maintain brightness (126). This step compensates for the reduced integration time by boosting the gain, ensuring that the captured image remains properly exposed.

If no at 123, camera processor 14 increases the integration time to match the flicker period (128). Camera processor 14 then sets the gain to a decreased sensitivity (e.g., less than 1.0 gain) to maintain brightness and avoid clipping (130). This step effectively turns on the reduced sensitivity mode, as described above in the disclosure. By toggling the reset and transfer gate voltages during the integration time using the reduced sensitivity mode, camera processor 14 reduces the pixel sensitivity, preventing saturation and clipping in high light conditions while maintaining the desired brightness level. In addition, flicker and flicker banding are reduced or eliminated.

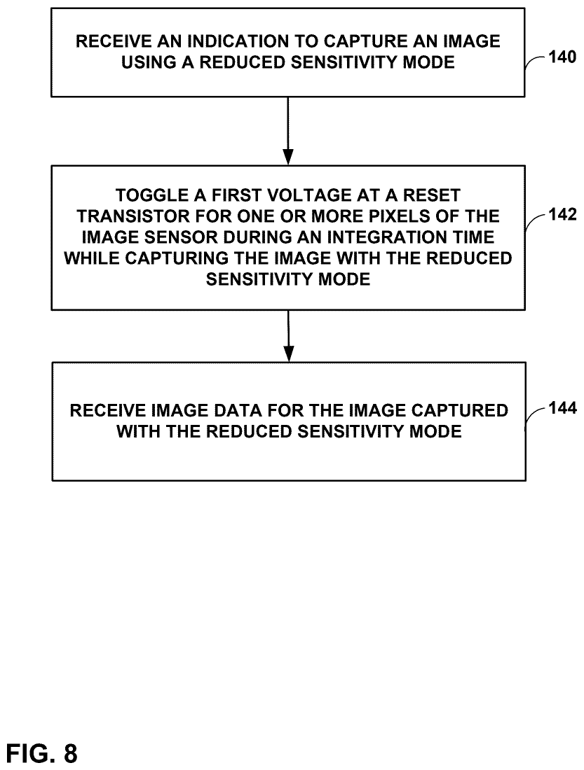

FIG. 8 illustrates a flow chart illustrating an example process for capturing an image using a reduced sensitivity mode according to the techniques of this disclosure. The techniques of FIG. 8 may be performed by one or more of processing circuitry 42 of FIG. 2 or camera processor 14 of FIG. 1. As shown in FIG. 8, processing circuitry 42 of sensor module 12 may be configured to receive an indication to capture an image using a reduced sensitivity mode (140). This indication can be based on various factors such as user input, lighting conditions, automatic exposure control settings (such as gain and integration time), flicker periods, or other specific requirements for the image capture scenario. In some examples, camera processor 14 may be configured to send an indication to sensor module 12 to capture an image using the reduced sensitivity mode. Processing circuitry 42 within sensor module 12 detects this indication (e.g., reads the indication stored in registers 44) and prepares image sensor 40 for operation in the reduced sensitivity mode.

Processing circuitry 42 may then cause image sensor 40 to toggle a first voltage at a reset transistor (RST) for one or more pixels of the image sensor during an integration time while capturing the image with the reduced sensitivity mode (142). Processing circuitry 42 may alternate the first voltage between a first low voltage level and a first high voltage level at a specified frequency. The first high voltage level is less than the reset voltage typically used to reset the photodiodes of the image sensor. This controlled toggling allows for partial resetting of the photodiodes, enabling the gradual drainage of charge during the integration period. This effectively reduces the pixel sensitivity, preventing saturation and clipping in high light conditions. Processing circuitry 42 may then receive image data for the image captured with the reduced sensitivity mode (144).

In other examples, processing circuitry 42 may cause image sensor 40 to toggle a second voltage at a transfer gate (TX) for one or more pixels in a four transistor (4T) pixel configuration. For example, processing circuitry 42 may cause image sensor 40 to alternate the second voltage between a second low voltage level and a second high voltage level at a second frequency, wherein the second high voltage level is less than a transfer voltage used to transfer respective charges from the photodiodes of the image sensor. In one example, at least one of the first high voltage level (e.g., for the RST) and the second high voltage level (e.g., for the TX) are the same, or the first frequency and the second frequency are the same. In other examples, at least one of the first high voltage level and the second high voltage level are different, or the first frequency and the second frequency are different.

In some examples of the disclosure, processing circuitry 42 and/or camera processor 14 may be configured to determine the use of the reduced sensitivity mode based on the integration time and a flicker period, ensuring synchronization with the flicker frequency of the light source to avoid flicker artifacts. Processing circuitry 42 and/or camera processor 14 may adjust the integration time and gain to maintain brightness and avoid clipping, effectively managing exposure and sensitivity in various lighting conditions. For example, processing circuitry 42 and/or camera processor 14 may determine a gain and the integration time for the image sensor, determine that the integration time is not above the flicker period, increase the integration time to match the flicker period, reduce the gain to be below 1, and determine to use the reduced sensitivity mode based on the gain being below 1.

The following describes one or more examples in accordance with the techniques described in this disclosure.
Aspect 1. An apparatus configured to capture an image, the apparatus comprising: an image sensor; and processing circuitry coupled to the image sensor, the processing circuitry configured to: receive an indication to capture an image using a reduced sensitivity mode; toggle a first voltage at a reset transistor for one or more pixelsof the image sensor during an integration time while capturing the image with the reduced sensitivity mode; and receive image data for the image captured with the reduced sensitivity mode.
Aspect 2. The apparatus of Aspect 1, wherein to toggle the first voltage at the reset transistor for one or more pixelsof the image sensor, the processing circuitry is configured to: alternate the first voltage between a first low voltage level and a first high voltage level at a first frequency, wherein the first high voltage level is less than a reset voltage used to reset photodiodes of the image sensor.
Aspect 3. The apparatus of Aspect 2, wherein the image sensor has a four transistor (4T) pixel configuration, and wherein the processing circuitry is further configured to: toggle a second voltage at a transfer gate for one or more pixelsof the image sensor during the integration time while capturing the image with the reduced sensitivity mode.
Aspect 4. The apparatus of Aspect 3, wherein to toggle the second voltage at the transfer gate for one or more pixelsof the image sensor, the processing circuitry is configured to: alternate the second voltage between a second low voltage level and a second high voltage level at a second frequency, wherein the second high voltage level is less than a transfer voltage used to transfer respective charges from the photodiodes of the image sensor.
Aspect 5. The apparatus of Aspect 4, wherein at least one of the first high voltage level and the second high voltage level are the same, or the first frequency and the second frequency are the same.
Aspect 6. The apparatus of Aspect 4, wherein at least one of the first high voltage level and the second high voltage level are different, or the first frequency and the second frequency are different.
Aspect 7. The apparatus of any of Aspects 1-6, wherein the processing circuitry is further configured to: determine to use the reduced sensitivity mode based on the integration time and a flicker period.
Aspect 8. The apparatus of Aspect 7, wherein determine to use the reduced sensitivity mode based on the integration time and the flicker period, the processing circuitry is configured to: determine a gain and the integration time for the image sensor; determine that the integration time is not above the flicker period; increase the integration time to match the flicker period; reduce the gain to be below 1; and determine to use the reduced sensitivity mode based on the gain being below 1.
Aspect 9. The apparatus of any of Aspects 1-6, wherein the processing circuitry is further configured to: determine to use the reduced sensitivity mode based on a user input.
Aspect 10. The apparatus of any of Aspects 1-9, wherein the apparatus is a wireless communication device.
Aspect 11. A method of capturing an image, the method comprising: receiving an indication to capture an image using a reduced sensitivity mode; toggling a first voltage at a reset transistor for one or more pixelsof an image sensor during an integration time while capturing the image with the reduced sensitivity mode; and receiving image data for the image captured with the reduced sensitivity mode.
Aspect 12. The method of Aspect 11, wherein toggling the first voltage at the reset transistor for one or more pixelsof the image sensor comprises: alternating the first voltage between a first low voltage level and a first high voltage level at a first frequency, wherein the first high voltage level is less than a reset voltage used to reset photodiodes of the image sensor.
Aspect 13. The method of Aspect 12, wherein the image sensor has a four transistor (4T) pixel configuration, the method further comprising: toggling a second voltage at a transfer gate for one or more pixelsof the image sensor during the integration time while capturing the image with the reduced sensitivity mode.
Aspect 14. The method of Aspect 13, wherein toggling the second voltage at the transfer gate for one or more pixelsof the image sensor comprises: alternating the second voltage between a second low voltage level and a second high voltage level at a second frequency, wherein the second high voltage level is less than a transfer voltage used to transfer respective charges from the photodiodes of the image sensor.
Aspect 15. The method of Aspect 14, wherein at least one of the first high voltage level and the second high voltage level are the same, or the first frequency and the second frequency are the same.
Aspect 16. The method of Aspect 14, wherein at least one of the first high voltage level and the second high voltage level are different, or the first frequency and the second frequency are different.
Aspect 17. The method of any of Aspects 11-16, further comprising: determining to use the reduced sensitivity mode based on the integration time and a flicker period.
Aspect 18. The method of Aspect 17, wherein determining to use the reduced sensitivity mode based on the integration time and the flicker period comprises: determining a gain and the integration time for the image sensor; determining that the integration time is not above the flicker period; increasing the integration time to match the flicker period; reducing the gain to be below 1; and determining to use the reduced sensitivity mode based on the gain being below 1.
Aspect 19. The method of any of Aspects 11-16, further comprising: determining to use the reduced sensitivity mode based on a user input.
Aspect 20. A non-transitory computer-readable storage medium storing instructions that, when executed, cause one or more processors of a device configured to capture an image to: receive an indication to capture an image using a reduced sensitivity mode; toggle a first voltage at a reset transistor for one or more pixelsof an image sensor during an integration time while capturing the image with the reduced sensitivity mode; and receive image data for the image captured with the reduced sensitivity mode.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured to capture an image, the apparatus comprising:
an image sensor; and
processing circuitry coupled to the image sensor, the processing circuitry configured to:
receive an indication to capture an image using a reduced sensitivity mode;
toggle a first voltage at a reset transistor for one or more pixels of the image sensor during an integration time while capturing the image with the reduced sensitivity mode; and
receive image data for the image captured with the reduced sensitivity mode.

2. The apparatus of claim 1, wherein to toggle the first voltage at the reset transistor for one or more pixels of the image sensor, the processing circuitry is configured to:
alternate the first voltage between a first low voltage level and a first high voltage level at a first frequency, wherein the first high voltage level is less than a reset voltage used to reset photodiodes of the image sensor.

3. The apparatus of claim 2, wherein the image sensor has a four transistor (4T) pixel configuration, and wherein the processing circuitry is further configured to:
toggle a second voltage at a transfer gate for one or more pixels of the image sensor during the integration time while capturing the image with the reduced sensitivity mode.

4. The apparatus of claim 3, wherein to toggle the second voltage at the transfer gate for one or more pixels of the image sensor, the processing circuitry is configured to:
alternate the second voltage between a second low voltage level and a second high voltage level at a second frequency, wherein the second high voltage level is less than a transfer voltage used to transfer respective charges from the photodiodes of the image sensor.

5. The apparatus of claim 4, wherein at least one of the first high voltage level and the second high voltage level are the same, or the first frequency and the second frequency are the same.

6. The apparatus of claim 4, wherein at least one of the first high voltage level and the second high voltage level are different, or the first frequency and the second frequency are different.

7. The apparatus of claim 1, wherein the processing circuitry is further configured to:
determine to use the reduced sensitivity mode based on the integration time and a flicker period.

8. The apparatus of claim 7, wherein determine to use the reduced sensitivity mode based on the integration time and the flicker period, the processing circuitry is configured to:
determine a gain and the integration time for the image sensor;
determine that the integration time is not above the flicker period;
increase the integration time to match the flicker period;
reduce the gain to be below 1; and
determine to use the reduced sensitivity mode based on the gain being below 1.

9. The apparatus of claim 1, wherein the processing circuitry is further configured to:
determine to use the reduced sensitivity mode based on a user input.

10. The apparatus of claim 1, wherein the apparatus is a wireless communication device.

11. A method of capturing an image, the method comprising:
receiving an indication to capture an image using a reduced sensitivity mode;
toggling a first voltage at a reset transistor for one or more pixels of an image sensor during an integration time while capturing the image with the reduced sensitivity mode; and
receiving image data for the image captured with the reduced sensitivity mode.

12. The method of claim 11, wherein toggling the first voltage at the reset transistor for each pixel of the image sensor comprises:
alternating the first voltage between a first low voltage level and a first high voltage level at a first frequency, wherein the first high voltage level is less than a reset voltage used to reset photodiodes of the image sensor.

13. The method of claim 12, wherein the image sensor has a four transistor (4T) pixel configuration, the method further comprising:
toggling a second voltage at a transfer gate for each pixel of the image sensor during the integration time while capturing the image with the reduced sensitivity mode.

14. The method of claim 13, wherein toggling the second voltage at the transfer gate for each pixel of the image sensor comprises:
alternating the second voltage between a second low voltage level and a second high voltage level at a second frequency, wherein the second high voltage level is less than a transfer voltage used to transfer respective charges from the photodiodes of the image sensor.

15. The method of claim 14, wherein at least one of the first high voltage level and the second high voltage level are the same, or the first frequency and the second frequency are the same.

16. The method of claim 14, wherein at least one of the first high voltage level and the second high voltage level are different, or the first frequency and the second frequency are different.

17. The method of claim 11, further comprising:
determining to use the reduced sensitivity mode based on the integration time and a flicker period.

18. The method of claim 17, wherein determining to use the reduced sensitivity mode based on the integration time and the flicker period comprises:
determining a gain and the integration time for the image sensor;
determining that the integration time is not above the flicker period;
increasing the integration time to match the flicker period;
reducing the gain to be below 1; and
determining to use the reduced sensitivity mode based on the gain being below 1.

19. The method of claim 11, further comprising:
determining to use the reduced sensitivity mode based on a user input.

20. A non-transitory computer-readable storage medium storing instructions that, when executed, cause one or more processors of a device configured to capture an image to:
receive an indication to capture an image using a reduced sensitivity mode;
toggle a first voltage at a reset transistor for each pixel of an image sensor during an integration time while capturing the image with the reduced sensitivity mode; and
receive image data for the image captured with the reduced sensitivity mode.
